(19) United States
(12) Patent Application Publication
(10) Pub. No.: US 2021/0018081 A1
(43) Pub. Date: Jan. 21, 2021

(54) STRAIN WAVE GEARING

(71) Applicant: Harmonic Drive Systems Inc., Tokyo (JP)

(72) Inventor: Takeo KODAIRA, Azumino-shi (JP)

(73) Assignee: Harmonic Drive Systems Inc., Tokyo (JP)

(21) Appl. No.: 16/907,477

(22) Filed: Jun. 22, 2020

(30) Foreign Application Priority Data
Jul. 19, 2019 (JP) PCT/JP2019/028540

(51) Int. Cl. F16H 49/00; F16H 1/32

(52) U.S. Cl. CPC F16H 49/001; F16H 55/0833; F16H 1/32

(57) ABSTRACT

A strain wave gearing has a cup-shaped externally toothed gear that is provided with a body formed with external teeth, a diaphragm extending from an end of the body, and a rigid boss integrally formed in the diaphragm. The ratio B/A is set equal to or less than 0.59 where A is the reference pitch circle diameter of the external teeth and B is the outer diameter of the boss. The radial length from the inner peripheral edge of the diaphragm to the outer peripheral edge thereof in the present externally toothed gear is large. This enables to reduce bending stress generated in each part of the externally toothed gear due to coning, and a meshing state of the external teeth with the internal teeth in the tooth trace direction can also be improved, whereby further flattening of the externally toothed gear can be realized.

### TECHNICAL FIELD

The present invention relates to a strain wave gearing, and in particular, to a strain wave gearing provided with a cup-shaped externally toothed gear.

### BACKGROUND ART

A strain wave gearing provided with a cup-shaped externally toothed gear is disclosed in JP 2014-206265 A, for example. A cup-shaped externally toothed gear, which is flexed into an elliptical shape by a wave generator, is provided with a cylindrical body capable of being flexed in a radial direction, external teeth formed on the outer circumferential surface portion at a side of one end of the body, a diaphragm extending radially inward from the other end of the body, and a rigid boss having an annular shape formed integrally on the inner peripheral edge of the diaphragm. The boss functions as an attachment flange for attaching the externally toothed gear to another member. In the strain wave gearing disclosed in the above-mentioned patent document, the boss of the cup-shaped externally toothed gear is coaxially connected to the inner ring of a crossed-roller bearing, the inner ring functioning as an output shaft.

FIGS. 3(A) to 3(D) are explanatory views showing an initial state of the cup-shaped externally toothed gear and a state thereof after being flexed elliptically. Specifically, FIG. 3(A) shows a true circle C1, which is the shape of the externally toothed gear 130 before being flexed by a wave generator 140, and an ellipse C2, which is the shape of the externally toothed gear 130 after being flexed by the wave generator 140. FIG. 3(B) is an explanatory view showing a cross-section of the cup-shaped externally toothed gear 130 in the initial state of a true circle C1. FIG. 3(C) is an explanatory view showing a cross-section including the major axis L1 of an ellipse C2 of the cup-shaped externally toothed gear 130 in a flexed state, and FIG. 3(D) is an explanatory view showing a cross-section including the minor axis L2 of the ellipse C2 of the cup-shaped externally toothed gear 130 in the flexed state.

In the cross-section including the major axis L1 of the ellipse C2 shown in FIG. 3(C), the portion where the external teeth 132 are formed in the cylindrical body 131 of the externally toothed gear 130 is flexed as follows. The portion where the external teeth 132 is formed is flexed outward in the radial direction, and the amount of radially-outward flexion thereof is gradually increased from the rear end 132b of the external teeth 132 toward the front end 132a at an opening side thereof along the tooth trace direction. In the cross-section including the minor axis L2 of the ellipse C2 shown in FIG. 3(D), the portion where the external teeth 132 is formed is flexed inward in the radial direction, and the amount of radially-inward flexion thereof is gradually decreased from the rear end 132b toward the front end 132a. The flexing state in this way of the externally toothed gear 3 is called “coning.”

In the prior art, the dimensions of the diaphragm and the boss in a cup-shaped externally toothed gear are set as follows. As the outer diameter dimension of the diaphragm, the reference pitch circle diameter of the external teeth is used. The external teeth are formed in the cylindrical body connected to the outer peripheral edge of the diaphragm. The diaphragm and boss are designed so that the ratio B/A is within the range from 0.6 to 0.7, where A is the reference pitch circle diameter of the external teeth and B is the outer diameter of the boss.

Here, changing the dimensional ratio B/A of the diaphragm and the boss formed in the center of the diaphragm has not been focused on in the prior art.

### SUMMARY OF THE INVENTION

In view of the above point, an object of the present invention is to provide a strain wave gearing provided with an externally toothed gear, which is able to reduce bending stress generated in a diaphragm due to coning, suppress the change in meshing state of both gears in the tooth trace direction, and make the externally tooted gear more flat by means of appropriately setting the relationship in size between the diaphragm and the boss.

A strain wave gearing according to the present invention is provided with a cup-shaped flexible externally tooted gear. The externally toothed gear is provided with a cylindrical body capable of being flexed in a radial direction, external teeth formed on the outer circumferential surface portion at a side of one end in the direction of the center axis line in the body, a discoid diaphragm extending inward in the radial direction from the other end of the body, and a rigid boss which is integrally and coaxially formed in the diaphragm or is coaxially connected to the diaphragm. Where A is the reference pitch circle diameter of the externally teeth and B is the outer diameter of the boss B, the maximum value of the ratio B/A is 0.59.

As compared with a case of conventional design in which an externally toothed gear is provided with a diaphragm having the same outer diameter, in the externally toothed gear according to the present invention, a sufficient radial length from the inner peripheral edge of the diaphragm connected to the boss to the outer peripheral edge thereof, is obtained. This can reduce the amount of flexion generated in the inner peripheral edge, outer peripheral edge or other part of the diaphragm due to the coning of the externally toothed gear, and also reduce the change in amount of flexion in the tooth trace direction of the external teeth.

As a result, the bending stress generated at each section of the externally toothed gear can be reduced, and meshing state in the tooth trace direction of the external teeth with the internal teeth can also be improved. Therefore, it is possible to realize further flattening of the externally toothed gear.

A boss is usually integrally formed with a diaphragm. In other words, the boss and the diaphragm are manufactured as a single component. Instead of integrally forming the boss with the diaphragm, it is possible for the boss to be manufactured as a separate component from the diaphragm and coaxially connected to the diaphragm.

### BRIEF DESCRIPTION OF THE DRAWINGS

FIG. 1(A) is a cross-sectional view showing a strain wave gearing according to the present invention, FIG. 1(B) is an explanatory view showing a meshing state of an externally toothed gear with an internally toothed gear, and FIG. 1(C) is a cross-sectional view showing an externally toothed gear;

FIGS. 2(A) to 2(D) are explanatory views showing examples of a cup-shaped externally toothed gear; and

FIGS. 3(A) to 3(D) are explanatory views showing coning of an externally toothed gear.

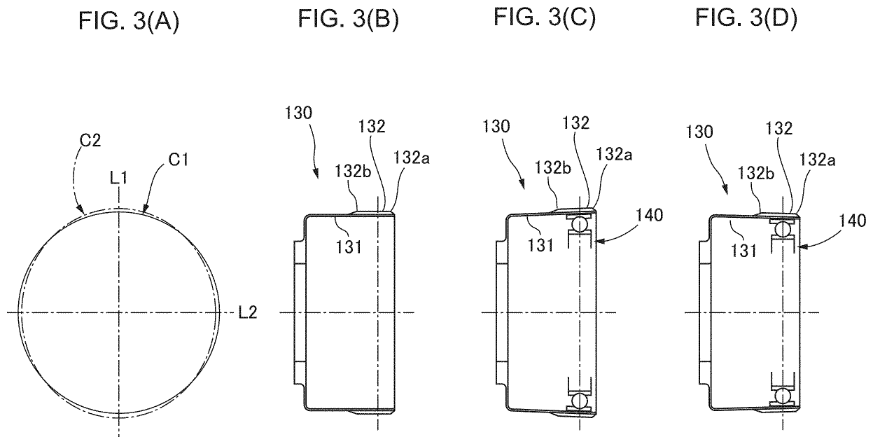

### MODE FOR CARRYING OUT THE INVENTION

An embodiment of a strain wave gearing according to the present invention will be described with reference to the drawings.

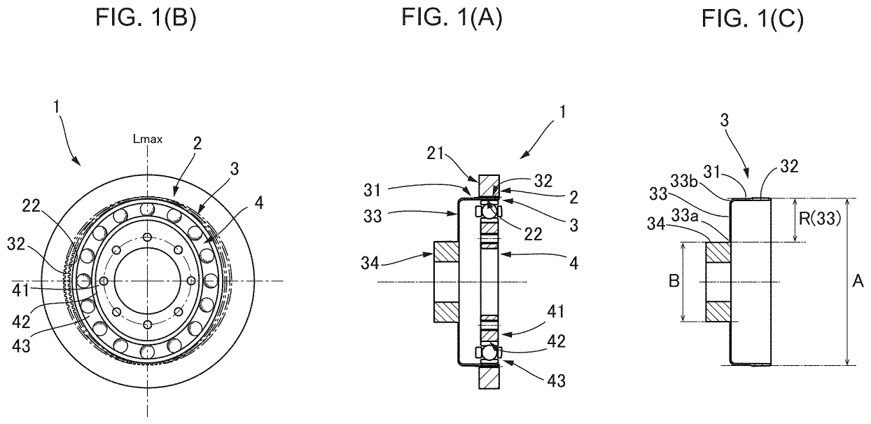

As shown in FIGS. 1(A) to 1(C), a strain wave gearing 1 according to an embodiment of the present invention is provided with a circular rigid internally toothed gear 2, a cup-shaped flexible externally toothed gear 3, and a wave generator 4.

The internally toothed gear 2 is provided with a rigid annular member 21 and internal teeth 22 formed on a circular inner circumferential surface of the rigid annular member 21. The externally toothed gear 3 is provided with cylindrical body 31, external teeth 32 formed on the outer circumferential surface at a side of one end or an opening end of the body 31, a discoid diaphragm 33 extending inward in the radial direction from the other end of the body 31, a rigid boss 34 connected to the inner peripheral edge of the diaphragm 33. The boss 34 has an annular shape and is provided with a hollow part passing to penetrate a center portion thereof in the direction of the center axis line. The external teeth 32 face internal teeth 22 of the internally toothed gear 2 from the inner side in the radial direction, and are capable of meshing with the internal teeth 22.

The wave generator 4 is coaxially fitted into the inner side of the portion of the body 31 of the externally toothed gear 3 where the external teeth 32 are formed. The wave generator 4 is provided with an annular (hollow-shaft-shaped) rigid plug 41, and a wave bearing 43 fitted on an outer circumferential surface 42 of the plug 41. The outer circumferential surface 42 has a non-circular profile, in this embodiment, an elliptical profile. The wave generator 4 flexes the portion of the externally toothed gear 3 where the external teeth 32 are formed into an elliptical shape. External teeth 32, which are located on both end portions of the major axis Lmax of the elliptical shape, are meshed with the internal teeth 22.

For example, the internally toothed gear 2 is a stationary-side member, the externally toothed gear 3 is a driven-side member, and the wave generator 4 is an input-side member into which rotation from a not-shown motor or the like is inputted. When the wave generator 4 rotates, the meshing position between the both gears 2 and 3 moves in the circumferential direction. Relative rotation, which is generated between the both gears 2 and 3 in accordance with the difference in the number of teeth between the gears 2 and 3, is output from the externally toothed gear 3 to the side of a not-shown load member.

As shown in FIG. 1(C), A is the reference pitch circle diameter of the external teeth 32 of the externally toothed gear 3, and B is the outer diameter of the boss 34. The externally toothed gear 3 is designed so that the ratio B/A is equal to or less than 0.59.

Comparison is made between the externally toothed gear of the present embodiment and a conventionally designed one in which the outer diameter is the same as of the present embodiment (in other words, the reference pitch diameter is A) but the ratio B/A is between 0.6 and 0.7. The length R(33) of the present embodiment is larger than the conventional one, the length R(33) being a dimension in the radial direction from the inner peripheral edge 33a of the diaphragm 33 connected to the boss 34 to the outer peripheral edge 33b of the diaphragm 33. This enables to reduce the amount of flexion which is caused by the coning of the externally toothed gear 3 and is generated in the inner peripheral edge 33a connected to the boss 34 or other part of the diaphragm 33, so that the change in the amount of flexion along the tooth trace direction of the external teeth 32 can be suppressed. As a result, the bending stress generated in each part of the externally toothed gear 3 can be reduced and a meshing state of the external teeth 32 with the internal teeth 22 along the tooth trace direction can also be improved. It is also advantageous in flattening of the externally toothed gear 3.

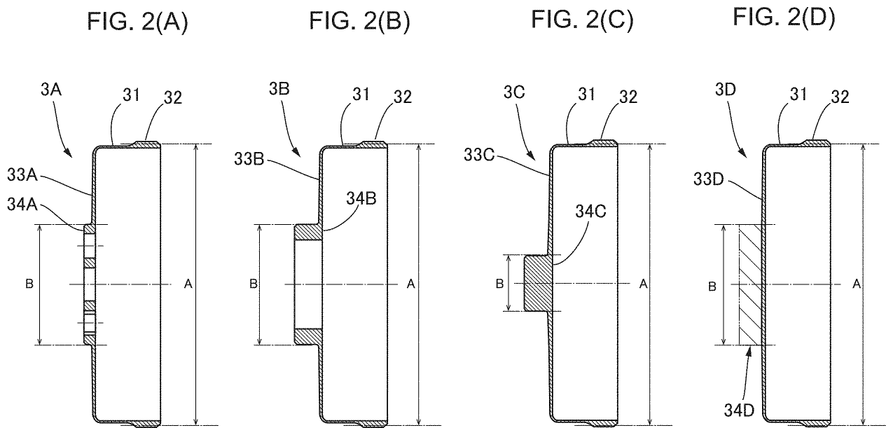

FIGS. 2(A) to 2(D) are explanatory views showing cup-shaped externally toothed gears having various shapes. These externally toothed gears can be used instead of the above-mentioned externally toothed gear 3.

An externally toothed gear 3A shown in FIG. 2(A) is provided with a cylindrical body 31 formed with external teeth 32, a diaphragm 33A, and a boss 34A integrally formed in the diaphragm 33A. The ratio B/A, in which A is the reference pitch circle diameter of the external teeth 32 and B is the outer diameter of the boss 34A, is set to be 0.5, for example.

An externally toothed gear 3B shown in FIG. 2(B) has the same configuration as of the externally toothed gear 3 shown in FIG. 1 and is provided with a cylindrical body 31 formed with external teeth 32, a diaphragm 33B, and a boss 34B integrally formed in the diaphragm 33B. The ratio B/A, in which A is the reference pitch circle diameter of the external teeth 32 and B is the outer diameter of the boss 34B, is set to be 0.5, for example.

An externally toothed gear 3C shown in FIG. 2(C) is provided with a cylindrical body 31 formed with external teeth 32, a diaphragm 33C, and a boss 34C integrally formed in the diaphragm 33C. The ratio B/A, in which A is the reference pitch circle diameter of the external teeth 32 and B is the outer diameter of the boss 34C, is set to be 0.25, for example.

An externally toothed gear 3D shown in FIG. 2(D) is provided with a main body and a boss 34D, in which the main body is constituted by a cylindrical body 31 formed with external teeth 32 and a diaphragm 33D, and the boss 34D is attached coaxially to the center portion of the diaphragm 33D. The boss 34D has a discoid shape (or a solid-shaft shape) and is manufactured as a separate member from the diaphragm 33D. The boss 34D or instead a load-side member is coaxially connected to the center portion of the diaphragm 33D. The ratio B/A, in which A is the reference pitch circle diameter of the external teeth 32 and B is the outer diameter of the boss 34D, is set to be 0.5, for example.

1. A strain wave gearing, comprising:
a rigid internally toothed gear;
a cup-shaped externally toothed gear; and
a wave generator,
wherein the externally toothed gear is provided with:
a cylindrical body flexible in a radial direction;
external teeth formed on an outer circumferential surface portion of the body at a side of one end in a direction of a center axis line of the body;
a discoid diaphragm extending inward in the radial direction from the other end of the body; and
a rigid boss that is coaxially and integrally formed in the diaphragm or is coaxially connected to the diaphragm, and
wherein a maximum value of a ratio B/A is 0.59 where A is a reference pitch circle diameter of the external teeth and B is an outer diameter of the boss

2. The strain wave gearing according to claim 1,
wherein the boss is integrally formed in a center portion of the diaphragm.

3. The strain wave gearing according to claim 1,
wherein the boss is coaxially connected to the diaphragm.

4. The strain wave gearing according to claim 1,
wherein the boss is provided with a hollow part passing to penetrate a center portion thereof in the direction of the center axis line.
